(19) United States
(12) Patent Application Publication
(10) Pub. No.: US 2026/0038519 A1
(43) Pub. Date: Feb. 5, 2026

(54) SCENE AUDIO SIGNAL DECODING METHOD AND APPARATUS

(71) Applicant: HUAWEI TECHNOLOGIES CO., LTD., Shenzhen (CN)

(72) Inventors: Shuai Liu, Beijing (CN); Yuan Gao, Beijing (CN); Bingyin Xia, Beijing (CN); Zhe Wang, Beijing (CN)

(73) Assignee: HUAWEI TECHNOLOGIES CO., LTD., Shenzhen (CN)

(21) Appl. No.: 19/355,093

(22) Filed: Oct. 10, 2025

Related U.S. Application Data
(63) Continuation of application No. PCT/CN2024/086389, filed on Apr. 7, 2024.

(30) Foreign Application Priority Data
Apr. 13, 2023 (CN) 202310437643.1

(51) Int. Cl. G10L 19/008

(52) U.S. Cl. CPC G10L 19/008

(57) ABSTRACT

A scene audio signal decoding method is provided, including: obtaining a transient identifier of a first channel in a to-be-reconstructed scene audio signal, where the to-be-reconstructed scene audio signal includes C channels, the C channels include a channel on which direct decoding is performed and a channel on which direct decoding is not performed, the first channel is a channel on which direct decoding is not performed, the transient identifier indicates whether a transient signal exists on the corresponding channel, and C is a positive integer; and obtaining a reconstructed signal with the first channel when the transient identifier indicates that a transient signal exists on the first channel. According to this method, a transient signal in a scene audio signal can be processed, to improve quality of a reconstructed scene audio signal and auditory experience of a user.

### CROSS-REFERENCE TO RELATED APPLICATIONS

This application is a continuation of International Application No. PCT/CN2024/086389, filed on Apr. 7, 2024, which claims priority to Chinese Patent Application No. 202310437643.1, filed on Apr. 13, 2023. The disclosures of the aforementioned applications are hereby incorporated by reference in their entireties.

### TECHNICAL FIELD

This application relates to audio encoding and decoding technologies, and in particular, to a scene audio signal decoding method and apparatus.

### BACKGROUND

A three-dimensional audio technology is an audio technology for obtaining, processing, transmitting, rendering, and playing back sound events and three-dimensional sound field information in the real world through a computer, signal processing, or the like. Three-dimensional audio enables a sound to have a strong sense of space, envelopment, and immersion, and provides people with extraordinary “immersive” auditory experience. In a higher-order ambisonics (HOA) technology, recording, encoding, and playback stages are unrelated to a speaker layout, data in a HOA format is rotatably played back, and there is higher flexibility in playback of the three-dimensional audio. Therefore, there is more extensive attention and research.

In the HOA technology, a large amount of data needs to be used to record more detailed sound scene information, to achieve better audio auditory effect. Scene-based three-dimensional audio signal sampling and storage are more conducive to storage and transmission of spatial information of an audio signal. However, a channel quantity corresponding to an N^{th}-order HOA signal is (N+1)². As an HOA order quantity increases, more data is generated. A large amount of data may result in difficulty in transmission and storage. Therefore, the HOA signal needs to be encoded and decoded.

In a related technology, a part of channels may be encoded and decoded to reduce a bitstream size and improve encoding and decoding efficiency. However, processing of a transient signal is not considered, resulting in deterioration of quality of a reconstructed audio signal and affecting auditory experience of a user.

### SUMMARY

This application provides a scene audio signal decoding method and apparatus, so that a transient signal in a scene audio signal is processed, to improve quality of a reconstructed scene audio signal and auditory experience of a user.

According to a first aspect, this application provides a scene audio signal encoding and decoding method, including: obtaining a transient identifier of a first channel in a to-be-reconstructed scene audio signal, where the to-be-reconstructed scene audio signal includes C channels, the C channels include a channel on which direct decoding is performed and a channel on which direct decoding is not performed, the first channel is a channel on which direct decoding is not performed, the transient identifier indicates whether a transient signal exists on the corresponding channel, and C is a positive integer; and obtaining a reconstructed signal with the first channel when the transient identifier indicates that a transient signal exists on the first channel.

In an embodiment of the application, a decoder side implements, based on a transient identifier of a channel, transient recovery on a reconstructed signal with a channel on which a transient signal exists, so that a transient signal in the scene audio signal can be processed, to improve quality of a reconstructed scene audio signal and auditory experience of a user.

The first channel is a channel on which direct decoding is not performed in the C channels included in the reconstructed scene audio signal. C is a positive integer. In other words, the first channel may be a channel on which spatial decoding or de-correlation is performed in the C channels. For example, when a rate is 256 kbps, the first channel is one of channels 6 to 8 and 11 to 15 on which spatial decoding is performed, or one of channels 5, 9, 10, and 16 on which de-correlation is performed. When the rate is 384 kbps, the first channel is one of channels 6 to 8 and 11 to 15 on which spatial decoding is performed, or one of channels 5, 9, 10, and 16 on which de-correlation is performed. When the rate is 512 kbps, the first channel is one of channels 7 to 9 and 11 to 15 on which spatial decoding is performed, or channel 10 or 16 on which de-correlation is performed. When the rate is 768 kbps, the first channel is one of channels 11 to 15 on which spatial decoding is performed, or channel 10 or 16 on which de-correlation is performed. Direct decoding processing may be a decoding scheme in which encoded data obtained by encoding a signal is decoded.

In an embodiment of the application, the first channel may be a channel on which de-correlation is performed.

The transient identifier indicates whether a transient signal exists on the corresponding channel.

In an embodiment, the decoder side may perform transient detection on the first channel, to obtain the transient identifier of the first channel.

Transient detection includes: The decoder side may calculate an energy difference between a high-frequency signal and a low-frequency signal with the first channel, and if the energy difference is greater than a first threshold, determine that a transient signal exists on the first channel, or if the energy difference is not greater than a first threshold, determine that no transient signal exists on the first channel. The first threshold may be preset. A value of the first threshold is not specifically limited in this embodiment of this application. Then, the transient identifier of the first channel is assigned based on a transient detection result.

In an embodiment, the transient identifier may be represented by using a 1-bit syntax element. For example, 1 indicates that a transient signal exists, and 0 indicates that no transient signal exists. If a transient detection result of a channel is that a transient signal exists on the channel, a transient identifier of the channel is set to 1; or if a transient detection result of a channel is that no transient signal exists on the channel, a transient identifier of the channel is set to 0.

In an embodiment, the decoder side may obtain a transient identifier of a channel W in the C channels, and use the transient identifier of the channel W as the transient identifier of the first channel.

The decoder side may perform transient detection on the channel W when processing the channel W, to obtain the transient identifier of the channel W, and then assign the transient identifier of the channel W to another channel. That is, the transient identifier of the first channel is kept consistent with the transient identifier of the channel W.

In an embodiment, the decoder side may obtain transient identifiers of n channels in the C channels, where all the n channels are channels on which direct decoding is performed in the C channels; and obtain the transient identifier of the first channel based on the transient identifiers of the n channels. Herein, n is an integer greater than 1.

The n channels may be preset. For example, a channel on which transient detection needs to be performed is set in a channel transient detection table. The decoder side performs transient detection on a corresponding channel when processing the channel, to obtain a transient identifier. Then, the decoder side may determine transient identifiers of other channels based on a combination of the transient identifiers of the n channels. For example, transient of a channel in a horizontal direction may be used for a channel in the horizontal direction in the other channels, transient of a channel in a vertical direction may be used for a channel in the vertical direction in the other channels. In other words, the transient identifier of the first channel is related to the transient identifiers of the n channels.

In an embodiment, the decoder side may decode a bitstream, to obtain the transient identifier of the first channel.

An encoder side may also perform transient detection on the channel, write the transient identifier into the bitstream, and transmit the bitstream to the decoder side. In this way, the decoder side may obtain the transient identifier of the first channel by decoding the bitstream.

The decoder side may perform direct decoding on the received bitstream, to obtain a reconstructed signal with a second channel, where the second channel is a channel on which direct decoding is performed in the C channels; and obtain the reconstructed signal with the first channel based on the reconstructed signal with the second channel.

The reconstructed scene audio signal is an audio signal includes C channels. C is a positive integer. The decoder side may decode the bitstream by using at least two decoding schemes, to obtain the audio signal includes the C channels. The at least two decoding schemes include direct decoding.

A first reconstructed signal obtained by decoding the bitstream by the decoder side is an audio signal includes all channels on which direct decoding is performed, and the reconstructed signal with the second channel may be an audio signal includes any channel in the first reconstructed signal. For example, when a rate is 768 kbps, the reconstructed signal with the second channel is an audio signal includes any one of channels 1 to 9.

In an embodiment of the application, the second channel may be the channel W (namely, a channel numbered 1) in the C channels in the reconstructed scene audio signal.

In an embodiment, the decoder side may directly copy the reconstructed signal with the second channel as the reconstructed signal with the first channel.

In an embodiment, the decoder side may perform de-correlation based on the reconstructed signal with the second channel, to obtain the reconstructed signal with the first channel.

According to a second aspect, this application provides a scene audio signal decoding apparatus, including: an obtaining module, configured to obtain a transient identifier of a first channel in a to-be-reconstructed scene audio signal, where the to-be-reconstructed scene audio signal includes C channels, the C channels include a channel on which direct decoding is performed and a channel on which direct decoding is not performed, the first channel is a channel on which direct decoding is not performed, the transient identifier indicates whether a transient signal exists on the corresponding channel, and C is a positive integer; and a transient recovery module, configured to obtain a reconstructed signal with the first channel when the transient identifier indicates that a transient signal exists on the first channel.

In an embodiment, the first channel is a channel on which de-correlation is performed.

In an embodiment, the obtaining module is configured to perform transient detection on the first channel, to obtain the transient identifier of the first channel.

In an embodiment, the obtaining module is configured to: obtain a transient identifier of a channel W in the C channels, and use the transient identifier of the channel W as the transient identifier of the first channel.

In an embodiment, the obtaining module is configured to: obtain transient identifiers of n channels in the C channels, where all the n channels are channels on which direct decoding is performed, and n is an integer greater than 1; and obtain the transient identifier of the first channel based on the transient identifiers of the n channels.

In an embodiment, the obtaining module is configured to decode a bitstream, to obtain the transient identifier of the first channel.

In an embodiment, the transient recovery module is configured to: perform direct decoding on a received bitstream, to obtain a reconstructed signal with a second channel, where the second channel is a channel on which direct decoding is performed in the C channels; and obtain the reconstructed signal with the first channel based on the reconstructed signal with the second channel.

In an embodiment, the transient recovery module is configured to perform de-correlation based on the reconstructed signal with the second channel, to obtain the reconstructed signal with the first channel.

In an embodiment, the transient recovery module is configured to use the reconstructed signal with the second channel as the reconstructed signal with the first channel.

In an embodiment, the second channel is the channel W in the C channels.

According to a third aspect, this application provides an electronic device, including: one or more processors; and a memory, configured to store one or more programs. When the one or more programs are executed by the one or more processors, the one or more processors are enabled to implement the method according to any implementation of the first aspect.

According to a fourth aspect, this application provides a chip, including one or more interface circuits and one or more processors. The interface circuit is configured to: receive a signal from a memory of an electronic device, and send the signal to the processor, the signal includes computer instructions stored in the memory, and when the processor executes the computer instructions, the electronic device is enabled to perform the method according to any implementation of the first aspect.

According to a fifth aspect, this application provides a computer-readable storage medium. The computer-readable storage medium stores a computer program, and when the computer program is run on a computer or a processor, the computer or the processor is enabled to perform the method according to any implementation of the first aspect.

According to a sixth aspect, this application provides a computer program product. The computer program product includes computer program code, and when the computer program code is run on a computer, the computer is enabled to perform the method according to any implementation of the first aspect.

According to a seventh aspect, this application provides a bitstream storage apparatus. The apparatus includes a receiver and at least one storage medium, the receiver is configured to receive a bitstream, and the at least one storage medium is configured to store the bitstream.

According to an eighth aspect, this application provides a bitstream transmission apparatus. The apparatus includes a transmitter and at least one storage medium, the at least one storage medium is configured to store a bitstream, and the transmitter is configured to: obtain the bitstream from the storage medium, and send the bitstream to a terminal-side device by using a transmission medium.

According to a ninth aspect, this application provides a bitstream distribution system. The system includes: at least one storage medium, configured to store at least one bitstream; and a streaming media device, configured to: obtain the bitstream from the at least one storage medium, and send the bitstream to a terminal-side device. The streaming media device includes a content server or a content distribution server.

### BRIEF DESCRIPTION OF DRAWINGS

FIG. 1a is a diagram of an application scenario according to an embodiment of this application;

FIG. 1b is a diagram of an application scenario according to an embodiment of this application;

FIG. 2a is a diagram of a scene audio signal encoding process;

FIG. 2b is a diagram of a distribution of candidate virtual speakers;

FIG. 3 is a diagram of a scene audio signal decoding process;

FIG. 4 is a flowchart of a process 400 of a scene audio decoding method according to an embodiment of this application; and

FIG. 5 is a diagram of a structure of a scene audio signal decoding apparatus 500 according to an embodiment of the application.

### DESCRIPTION OF EMBODIMENTS

To make the objectives, technical solutions, and advantages of this application clearer, the following clearly describes the technical solutions of this application with reference to the accompanying drawings in this application. It is clear that, the described embodiments are merely some rather than all of embodiments of this application. All other embodiments obtained by one of ordinary skilled in the art based on embodiments of this application without creative efforts shall fall within the protection scope of this application.

In the specification, embodiments, claims, and accompanying drawings of this application, terms “first”, “second”, and the like are merely intended for distinguishing and description, and shall not be understood as an indication or implication of relative importance or an indication or implication of a sequence. In addition, the terms “include”, “have”, and any variant thereof are intended to cover non-exclusive inclusion, for example, include a series of operations or units. A method, a system, a product, or a device is not necessarily limited to clearly listed operations or units, but may include other operations or units that are not clearly listed and that are inherent to the process, the method, the product, or the device.

It should be understood that, in this application, “at least one” means one or more, and “a plurality of” means two or more. The term “and/or” is used for describing an association relationship between associated objects, and represents that three relationships may exist. For example, “A and/or B” may represent the following three cases: Only A exists, only B exists, and both A and B exist, where A and B may be singular or plural. The character “/” usually indicates an “or” relationship between the associated objects. “At least one of the following items (pieces)” or a similar expression thereof indicates any combination of these items, including a single item (piece) or any combination of a plurality of items (pieces). For example, at least one of a, b, or c may indicate a, b, c, a and b, a and c, b and c, or a, b, and c, where a, b, and c may be singular or plural.

The following briefly describes related technologies in embodiments of this application.

A sound is a continuous wave generated by an object through vibration. An object that vibrates to emit a sound wave is referred to as a sound source. In a process in which the sound wave is propagated through a medium (for example, air, solid, or liquid), an auditory organ of a person or an animal can sense the sound.

Features of the sound wave include a tone, intensity, and a timbre. The tone indicates a level of the sound. The intensity indicates volume of the sound. The intensity may also be referred to as loudness or volume. A unit of the intensity is decibel (dB). The timbre is also referred to as sound quality.

A frequency of the sound wave determines the level of the tone. A higher frequency indicates a higher tone. A quantity of times that the object vibrates in 1 second is referred to as a frequency, and a frequency unit is Hertz (Hz). A frequency of a sound that can be recognized by a human ear is between 20 Hz and 20000 Hz.

An amplitude of the sound wave determines the intensity. A larger amplitude indicates higher intensity. A shorter distance from the sound source indicates higher intensity.

A waveform of the sound wave determines the timbre. Waveforms of sound waves include a square wave, a sawtooth wave, a sine wave, a pulse wave, and the like.

Sounds may be classified into a regular sound and an irregular sound based on features of sound waves. The irregular sound is a sound emitted by the sound source through irregular vibration. The irregular sound is, for example, noise that affects people's work, study, rest, and the like. The regular sound is a sound emitted by the sound source through regular vibration. Regular sounds include a voice and a music sound. When a sound is represented electrically, the regular sound is an analog signal that changes continuously in time-frequency domain. The analog signal may be referred to as an audio signal. The audio signal is an information carrier that carries a voice, music, and a sound effect.

Because human's auditory sense has a capability of identifying location distribution of the sound source in space, when hearing a sound in space, a listener can sense an orientation of the sound in addition to a tone, intensity, and a timbre of the sound.

As attention to and quality requirements for experience of an auditory system increase, a three-dimensional audio technology emerges accordingly, to enhance a sense of depth, a sense of presence, and a sense of space of a sound. In this way, the listener not only senses sounds emitted from front, back, left, and right sound sources, but also senses a feeling that space in which the listener is located is surrounded by spatial sound fields (briefly referred to as “sound field”) generated by these sound sources, and a feeling that the sounds diffuse around, to create an “immersive” sound effect exerted when the listener is located in a place such as a theater or a concert hall.

A scene audio signal in embodiments of this application may be a signal used to describe a sound field. The scene audio signal may include an HOA signal (the HOA signal may include a three-dimensional HOA signal and a two-dimensional HOA signal (which may also be referred to as a planar HOA signal)) and a three-dimensional audio signal. The three-dimensional audio signal may be an audio signal in the scene audio signal other than the HOA signal. The following provides descriptions by using the HOA signal as an example.

It is well known that the sound wave is propagated in an ideal medium, a quantity of waves satisfies

$$k = \frac{w}{c} ,$$

and an angular frequency satisfies w=2πf. Herein, f is a sound wave frequency, and c is a sound speed. Sound pressure p satisfies Formula (1). Herein, ∇² is a Laplacian operator.

$${∇}^{2} p + {k}^{2} p = 0 \qquad ( 1 )$$

It is assumed that a spatial system outside the human ear is a sphere, and the listener is at the center of the sphere. A sound transmitted from the outside of the sphere has a projection on a spherical surface, and a sound outside the spherical surface is filtered out. It is assumed that a sound source is distributed on the spherical surface, and a sound field generated by the sound source on the spherical surface fits a sound field generated by an original sound source. That is, the three-dimensional audio technology is a sound field fitting method. In an embodiment, an equation, namely, Formula (1) is solved in a spherical coordinate system. In a passive spherical area, a solution to the equation, namely, Formula (1) is Formula (2).

$$p ( r , θ , φ , k ) = s {\sum }_{m = 0}^{∞} ( 2 m + 1 ) {j}^{m} {j}_{m}^{k r} ( k r ) {\sum }_{0 \leq n \leq m , σ = \pm 1} {Y}_{m , n}^{σ} ( {θ}_{s} , {φ}_{s} ) {Y}_{m , n}^{σ} ( θ , φ ) \qquad ( 2 )$$

Herein, r represents a sphere radius, θ represents horizontal angle information (or referred to as azimuth information), φ represents pitch angle information (or referred to as elevation angle information), k represents the quantity of waves, s represents an amplitude of an ideal plane wave, and m represents a sequence number of an order quantity of the HOA signal (or referred to as the sequence number of the order quantity of the HOA signal).

$${j}^{m} {j}_{m}^{k r} ( k r )$$

represents a sphere Bessel function, and the sphere Bessel function is also referred to as a radial basis function. The first “j” represents an imaginary unit, and

$$( 2 m + 1 ) {j}^{m} {j}_{m}^{k r} ( k r )$$

does not change with an angle.

$${Y}_{m , n}^{σ} ( θ , φ )$$

represents a spherical harmonic function in directions of θ and φ, and

$${Y}_{m , n}^{σ} ( {θ}_{s} , {φ}_{s} )$$

represents a spherical harmonic function in a direction of the sound source. The HOA signal satisfies Formula (3).

$${B}_{m , n}^{σ} = s \cdot {Y}_{m , n}^{σ} ( {θ}_{s} , {φ}_{s} ) \qquad ( 3 )$$

Formula (3) is substituted into Formula (2), and Formula (2) may be deformed into Formula (4).

$$p ( r , θ , φ , k ) = {\sum }_{m = 0}^{∞} {j}^{m} {j}_{m}^{k r} ( k r ) {\sum }_{0 \leq n \leq m , σ = \pm 1} {B}_{m , n}^{σ} {Y}_{m , n}^{σ} ( θ , φ ) \qquad ( 4 )$$

Herein, m is truncated to an N^{th} item, that is, m=N, and

$${B}_{m , n}^{σ}$$

is used as an approximate description of the sound field. In this case,

$${B}_{m , n}^{σ}$$

may be referred to as an HOA coefficient (which may be used to represent an N^{th}-order HOA signal). The sound field is an area in which a sound wave exists in a medium. N is an integer greater than or equal to 1.

The scene audio signal is an information carrier that carries spatial location information of a sound source in the sound field, and describes a sound field of a listener in space. Formula (4) indicates that the sound field may be expanded on the spherical surface based on the spherical harmonic function. In other words, the sound field may be decomposed into superimposition of a plurality of plane waves. Therefore, the sound field described by the HOA signal may be expressed through superimposition of a plurality of plane waves, and the sound field is reconstructed based on the HOA coefficient.

A to-be-encoded HOA signal may be an N^{th}-order HOA signal, and may be represented by using an HOA coefficient or an ambisonic coefficient. N is an integer greater than or equal to 1 (when N=1, a first-order HOA signal may be referred to as a first-order ambisonics (FOA) signal). The N^{th}-order HOA signal is an audio signal includes (N+1)² channels.

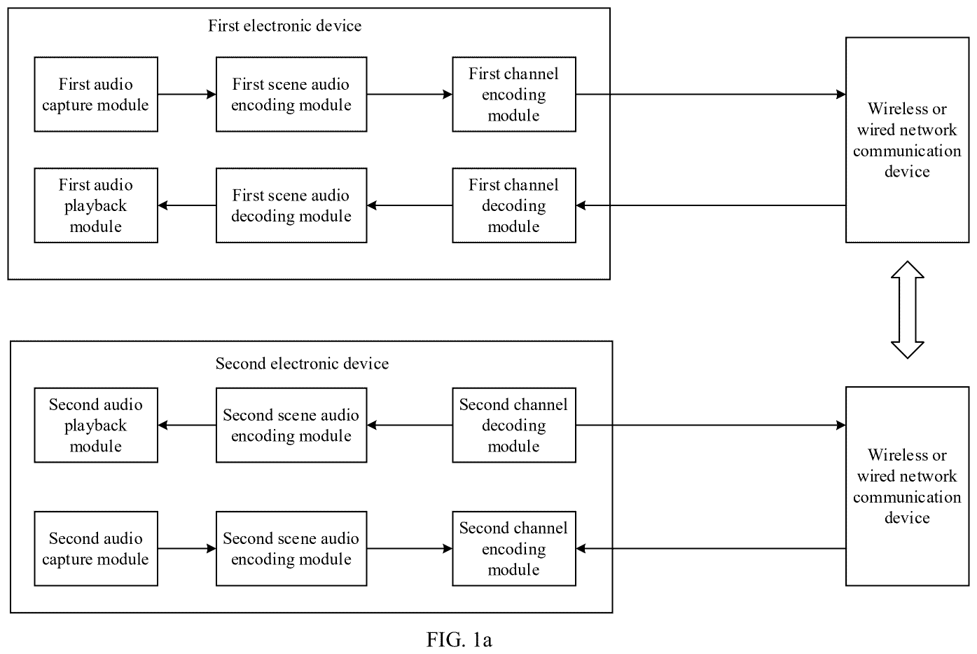

FIG. 1a is a diagram of an application scenario according to an embodiment of this application. As shown in FIG. 1a, the application scenario is a scene audio signal encoding and decoding scenario.

For example, a first electronic device may include a first audio capture module, a first scene audio encoding module, a first channel encoding module, a first channel decoding module, a first scene audio decoding module, and a first audio playback module. It should be understood that the first electronic device may include more or fewer modules than those shown in FIG. 1a. This is not specifically limited in this embodiment of this application.

For example, a second electronic device may include a second audio capture module, a second scene audio encoding module, a second channel encoding module, a second channel decoding module, a second scene audio decoding module, and a second audio playback module. It should be understood that the second electronic device may include more or fewer modules than those shown in FIG. 1a. This is not specifically limited in this embodiment of this application.

For example, a process in which the first electronic device encodes a scene audio signal and transmits the encoded scene audio signal to the second electronic device, and the second electronic device performs decoding and audio playback may include:

In the first electronic device, the first audio capture module may perform audio capture, and output the scene audio signal to the first scene audio encoding module. Then, the first scene audio encoding module may encode the scene audio signal, and output a bitstream to the first channel encoding module. Then, the first channel encoding module may perform channel encoding on the bitstream, and transmit, to the second electronic device through a wireless or wired network communication device, a bitstream obtained through channel encoding.

In the second electronic device, the second channel decoding module may perform channel decoding on received data, to obtain a bitstream and output the bitstream to the second scene audio decoding module. Then, the second scene audio decoding module may decode the bitstream, to obtain a reconstructed scene audio signal; and then output the reconstructed scene audio signal to the second audio playback module, and the second audio playback module performs audio playback.

It should be noted that the second audio playback module may perform post-processing (for example, audio rendering (for example, converting a reconstructed scene audio signal is an audio signal includes (N+1)² channels into an audio signal includes a same channel quantity as a quantity of speakers in the second electronic device), loudness normalization, user interaction, audio format conversion, or denoising) on the reconstructed scene audio signal, to convert the reconstructed scene audio signal into an audio signal suitable for playing by the speaker in the second electronic device.

It should be understood that a process in which the second electronic device encodes a scene audio signal and transmits the encoded scene audio signal to the first electronic device, and the first electronic device performs decoding and audio playback is similar to the foregoing process in which the first electronic device encodes the scene audio signal and transmits the encoded scene audio signal to the second electronic device, and the second electronic device performs decoding and audio playback. Details are not described herein again.

For example, the first electronic device and the second electronic device each may include but are not limited to a personal computer, a computer workstation, a smartphone, a tablet computer, a server, a smart camera, an intelligent vehicle, another type of cellular phone, a media consumption device, a wearable device, a set-top box, a game console, and the like.

For example, an embodiment of the application may be applied to a virtual reality (VR)/augmented reality (AR) scenario. In an embodiment, the first electronic device is a server, and the second electronic device is a VR/AR device. In an embodiment, the second electronic device is a server, and the first electronic device is a VR/AR device.

For example, the first scene audio encoding module and the second scene audio encoding module may be scene audio encoders. The first scene audio decoding module and the second scene audio decoding module may be scene audio decoders.

For example, when the first electronic device encodes the scene audio signal, and the second electronic device reconstructs the scene audio signal, the first electronic device may be referred to as an encoder side, and the second electronic device may be referred to as a decoder side. When the second electronic device encodes the scene audio signal, and the first electronic device reconstructs the scene audio signal, the second electronic device may be referred to as an encoder side, and the first electronic device may be referred to as a decoder side.

FIG. 1b is a diagram of an application scenario according to an embodiment of this application. As shown in FIG. 1b, the application scenario is a scene audio signal transcoding scenario.

As shown in (1) in FIG. 1b, for example, a wireless or core network device may include a channel decoding module, another audio decoding module, a scene audio encoding module, and a channel encoding module. The wireless or core network device may be configured to perform audio transcoding.

For example, an application scenario may be as follows: A first electronic device is not provided with a scene audio encoding module, and is provided with only another audio encoding module. A second electronic device is provided with only a scene audio decoding module, and is not provided with another audio decoding module. The wireless or core network device may be used for transcoding, so that the second electronic device can decode and play back a scene audio signal encoded by the first electronic device by using the another audio encoding module.

In an embodiment, the first electronic device encodes the scene audio signal by using the another audio encoding module, to obtain a first bitstream; and performs channel encoding on the first bitstream and sends the encoded first bitstream to the wireless or core network device. Then, the channel decoding module of the wireless or core network device may perform channel decoding, and output, to the another audio decoding module, the first bitstream obtained through channel decoding. Then, the another audio decoding module decodes the first bitstream, to obtain the scene audio signal, and outputs the scene audio signal to the scene audio encoding module. Then, the scene audio encoding module may encode the scene audio signal, to obtain a second bitstream, and output the second bitstream to the channel encoding module. After performing channel encoding on the second bitstream, the channel encoding module sends the encoded second bitstream to the second electronic device. In this way, the second electronic device may invoke the scene audio decoding module to decode the second bitstream obtained through channel decoding, to obtain a reconstructed scene audio signal; and subsequently, may perform audio playback on the reconstructed scene audio signal.

As shown in (2) in FIG. 1b, for example, a wireless or core network device may include a channel decoding module, a scene audio decoding module, another audio encoding module, and a channel encoding module. The wireless or core network device may be configured to perform audio transcoding.

For example, an application scenario may be as follows: A first electronic device is provided with only a scene audio encoding module, and is not provided with another audio encoding module. A second electronic device is not provided with a scene audio decoding module, and is only provided with another audio decoding module. The wireless or core network device may be used for transcoding, so that the second electronic device can decode and play back a scene audio signal encoded by the first electronic device by using the scene audio encoding module.

In an embodiment, the first electronic device encodes the scene audio signal by using the scene audio encoding module, to obtain a first bitstream; and performs channel encoding on the first bitstream and sends the encoded first bitstream to the wireless or core network device. Then, the channel decoding module of the wireless or core network device may perform channel decoding, and output, to the scene audio decoding module, the first bitstream obtained through channel decoding. Then, the scene audio decoding module decodes the first bitstream, to obtain the scene audio signal, and outputs the scene audio signal to the another audio encoding module. Then, the another audio encoding module may encode the scene audio signal, to obtain a second bitstream, and output the second bitstream to the channel encoding module. After performing channel encoding on the second bitstream, the channel encoding module sends the encoded second bitstream to the second electronic device. In this way, the second electronic device may invoke the another audio decoding module to decode the second bitstream obtained through channel decoding, to obtain a reconstructed scene audio signal; and subsequently, may perform audio playback on the reconstructed scene audio signal.

For a scene audio signal encoding process and a scene audio signal decoding process provided in a related technology, refer to the following description.

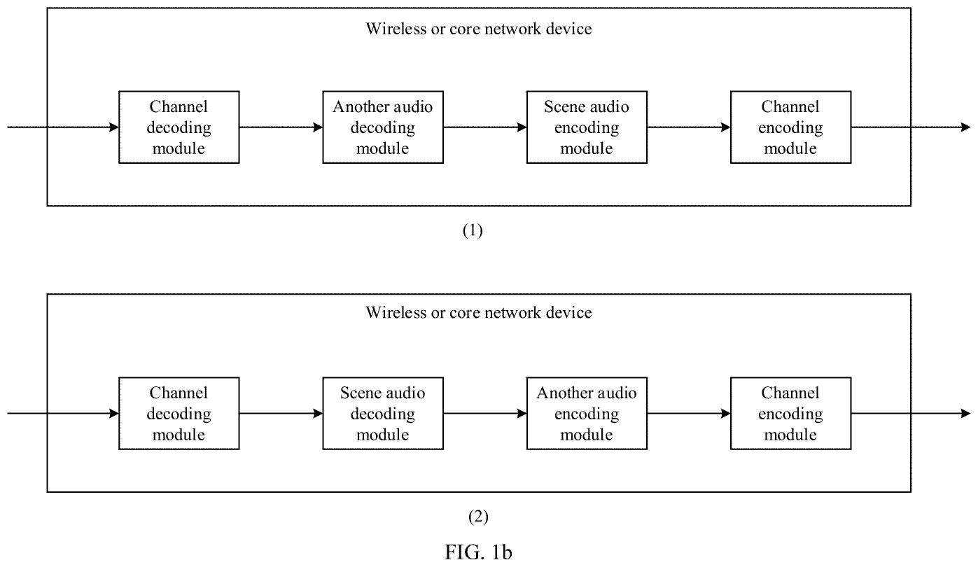

FIG. 2a is a diagram of a scene audio signal encoding process. As shown in FIG. 2a, the encoding process may include the following operations.
S201: Obtain a to-be-encoded scene audio signal, where the scene audio signal is an audio signal includes C channels, and C is a positive integer.

For example, when the scene audio signal is an HOA signal, the HOA signal may be an (N1)^{th}-order HOA signal, namely,

$${B}_{m , n}^{σ}$$

in Formula (3) when m is truncated to an (N1)^{th} item.

For example, the (N1)^{th}-order HOA signal may be an audio signal includes C1 channels. C1=(N1+1)². For example, when N1=3, a third-order HOA signal is an audio signal includes 16 channels; and when N1=4, a fourth-order HOA signal is an audio signal includes 25 channels.
S202: Determine attribute information of a target virtual speaker based on the scene audio signal.
S203: Encode a first audio signal in the scene audio signal and the attribute information of the target virtual speaker, to obtain a first bitstream, where the first audio signal is an audio signal includes K channels in the scene audio signal, and K is a positive integer less than or equal to C1.

For example, the virtual speaker is a speaker that is virtual, and is not a speaker that actually exists.

For example, the scene audio signal may be expressed through superimposition of a plurality of plane waves, and further, a target virtual speaker used to simulate a sound source in the scene audio signal may be determined. In this way, in a subsequent decoding process, a virtual speaker signal corresponding to the target virtual speaker is used to reconstruct the scene audio signal.

In an embodiment, a plurality of candidate virtual speakers at different locations may be disposed on a spherical surface; and then, a target virtual speaker whose location matches a location of the sound source in the scene audio signal may be selected from the plurality of candidate virtual speakers.

FIG. 2b is a diagram of a distribution of candidate virtual speakers. As shown in FIG. 2b, the plurality of candidate virtual speakers may be evenly distributed on the spherical surface, and one point on the spherical surface represents one candidate virtual speaker.

It should be noted that a quantity of candidate virtual speakers and a distribution of the candidate virtual speakers are not limited, and may be set according to a requirement.

For example, the target virtual speaker whose location corresponds to the location of the sound source in the scene audio signal may be selected from the plurality of candidate virtual speakers based on the scene audio signal. There may be one or more target virtual speakers. In an embodiment, the target virtual speaker may be preset.

For example, in an embodiment, in the decoding process, the scene audio signal may be reconstructed based on the virtual speaker signal. However, a bit rate is increased when the virtual speaker signal of the target virtual speaker is directly transmitted. The virtual speaker signal of the target virtual speaker may be generated based on the attribute information of the target virtual speaker and a scene audio signal includes a part or all of channels. Therefore, the attribute information of the target virtual speaker may be obtained, and the audio signal includes the K channels in the scene audio signal may be obtained as the first audio signal. Then, the first audio signal and the attribute information of the target virtual speaker are encoded, to obtain the first bitstream.

For example, operations such as downmixing, transformation, quantization, and entropy encoding may be performed on the first audio signal and the attribute information of the target virtual speaker, to obtain the first bitstream. In other words, the first bitstream may include encoded data of the first audio signal in the scene audio signal and encoded data of the attribute information of the target virtual speaker.

In addition, an encoder side directly encodes an audio signal includes a part of channels in the scene audio signal, without a need to calculate the virtual speaker signal and the residual signal, and encoding complexity of the encoder side is lower.

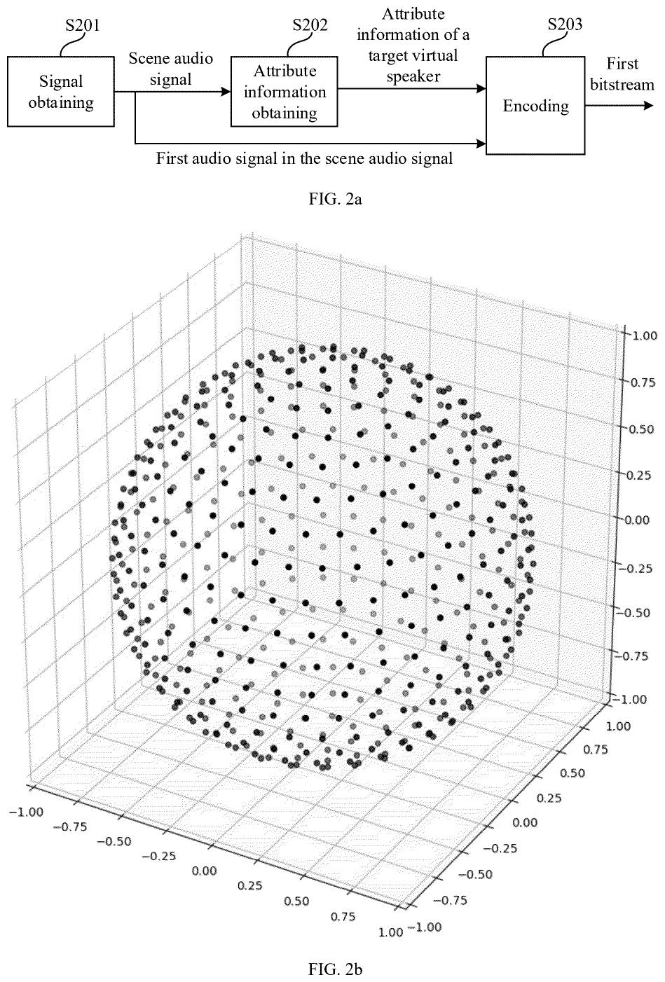

FIG. 3 is a diagram of a scene audio signal decoding process. FIG. 3 shows a decoding process corresponding to the encoding process in FIG. 2. As shown in FIG. 3, the decoding process may include the following operations.
S301: Receive a first bitstream.
S302: Decode the first bitstream, to obtain a first reconstructed signal and attribute information of a target virtual speaker.

For example, encoded data of a first audio signal in a scene audio signal included in the first bitstream may be decoded, to obtain the first reconstructed signal. That is, the first reconstructed signal is a reconstructed signal of the first audio signal. In addition, encoded data of the attribute information of the target virtual speaker included in the first bitstream may be decoded, to obtain the attribute information of the target virtual speaker.

It should be understood that, when an encoder side performs lossy compression on the first audio signal in the scene audio signal, a first reconstructed signal obtained by a decoder side through decoding is different from the first audio signal encoded by the encoder side. When the encoder side performs lossless compression on the first audio signal, a first reconstructed signal obtained by the decoder side through decoding is the same as the first audio signal encoded by the encoder side.

It should be understood that, when the encoder side performs lossy compression on the attribute information of the target virtual speaker, attribute information obtained by the decoder side through decoding is different from the attribute information encoded by the encoder side. When the encoder side performs lossless compression on the attribute information of the virtual speaker, attribute information obtained by the decoder side through decoding is the same as the attribute information encoded by the encoder side.
S303: Generate a virtual speaker signal corresponding to the target virtual speaker based on the attribute information and the first reconstructed signal.
S304: Perform reconstruction based on the attribute information and the virtual speaker signal, to obtain a first reconstructed scene audio signal.

For example, it can be learned, based on the foregoing descriptions, that the scene audio signal may be reconstructed based on the virtual speaker signal, and further, the virtual speaker signal corresponding to the target virtual speaker may be first generated based on the attribute information of the target virtual speaker and the first reconstructed signal. One target virtual speaker corresponds to one virtual speaker signal, and the virtual speaker signal is a plane wave. Then, reconstruction is performed based on the attribute information of the target virtual speaker and the virtual speaker signal, to generate the first reconstructed scene audio signal.

For example, when the scene audio signal is an HOA signal, the reconstructed first reconstructed scene audio signal may also be an HOA signal. The HOA signal may be an (N2)^{th} order HOA signal, and N2 is a positive integer. For example, the (N2)^{th}-order HOA signal may be an audio signal includes C2 channels. C2=(N2+1)².

For example, an order quantity N2 of the first reconstructed scene audio signal may be greater than or equal to an order quantity N1 of the scene audio signal in the embodiment in FIG. 2a. Correspondingly, a channel quantity C2 of an audio signal included in the first reconstructed scene audio signal may be greater than or equal to a channel quantity C1 of an audio signal included in the scene audio signal in the embodiment in FIG. 2a.

The scene audio signal encoding and the scene audio signal decoding process described in FIG. 2a to FIG. 3 may improve encoding and decoding efficiency, without considering processing of a transient signal, causing quality deterioration of a reconstructed audio signal, thereby affecting auditory experience of a user.

To resolve the foregoing technical problem, in the application scenarios shown in FIG. 1a and FIG. 1b, embodiments of this application provide a scene audio encoding method and apparatus. The following embodiments describe technical solutions thereof.

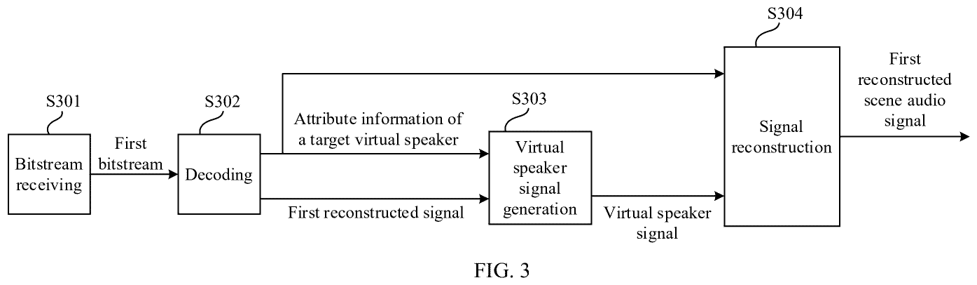

FIG. 4 is a flowchart of a process 400 of a scene audio decoding method according to an embodiment of this application. As shown in FIG. 4, the process 400 may be performed by a decoder side, for example, the foregoing second electronic device or the foregoing first electronic device. The process 400 is described as a series of steps or operations. It should be understood that the process 400 may be performed in various sequences and/or simultaneously, and is not limited to an execution sequence shown in FIG. 4. The process 400 includes the following operations.
Operation 401: Obtain a transient identifier of a first channel in a to-be-reconstructed scene audio signal.

The first channel is a channel on which direct decoding is not performed in C channels included in the reconstructed scene audio signal. C is a positive integer. In other words, the first channel may be a channel on which spatial decoding or de-correlation is performed in the C channels. For example, when a rate is 256 kbps, the first channel is one of channels 6 to 8 and 11 to 15 on which spatial decoding is performed, or one of channels 5, 9, 10, and 16 on which de-correlation is performed. When the rate is 384 kbps, the first channel is one of channels 6 to 8 and 11 to 15 on which spatial decoding is performed, or one of channels 5, 9, 10, and 16 on which de-correlation is performed. When the rate is 512 kbps, the first channel is one of channels 7 to 9 and 11 to 15 on which spatial decoding is performed, or channel 10 or 16 on which de-correlation is performed. When the rate is 768 kbps, the first channel is one of channels 11 to 15 on which spatial decoding is performed, or channel 10 or 16 on which de-correlation is performed.

In an embodiment of the application, the first channel may be a channel on which de-correlation is performed.

The transient identifier indicates whether a transient signal exists on the corresponding channel.

In an embodiment, the decoder side may perform transient detection on the first channel, to obtain the transient identifier of the first channel.

Transient detection includes: The decoder side may calculate an energy difference between a high-frequency signal and a low-frequency signal with the first channel, and if the energy difference is greater than a first threshold, determine that a transient signal exists on the first channel, or if the energy difference is not greater than a first threshold, determine that no transient signal exists on the first channel. The first threshold may be preset. A value of the first threshold is not specifically limited in this embodiment of this application. Then, the transient identifier of the first channel is assigned based on a transient detection result.

In an embodiment, the transient identifier may be represented by using a 1-bit syntax element. For example, 1 indicates that a transient signal exists, and 0 indicates that no transient signal exists. If a transient detection result of a channel is that a transient signal exists on the channel, a transient identifier of the channel is set to 1; or if a transient detection result of a channel is that no transient signal exists on the channel, a transient identifier of the channel is set to 0.

In an embodiment, the decoder side may obtain a transient identifier of a channel W in the C channels, and use the transient identifier of the channel W as the transient identifier of the first channel.

The decoder side may perform transient detection on the channel W when processing the channel W, to obtain the transient identifier of the channel W, and then assign the transient identifier of the channel W to another channel. That is, the transient identifier of the first channel is kept consistent with the transient identifier of the channel W.

In an embodiment, the decoder side may obtain transient identifiers of n channels in the C channels, where all the n channels are channels on which direct decoding is performed in the C channels; and obtain the transient identifier of the first channel based on the transient identifiers of the n channels. Herein, n is an integer greater than 1.

The n channels may be preset. For example, a channel on which transient detection needs to be performed is set in a channel transient detection table. The decoder side performs transient detection on a corresponding channel when processing the channel, to obtain a transient identifier. Then, the decoder side may determine transient identifiers of other channels based on a combination of the transient identifiers of the n channels. For example, transient of a channel in a horizontal direction may be used for a channel in the horizontal direction in the other channels, transient of a channel in a vertical direction may be used for a channel in the vertical direction in the other channels. In other words, the transient identifier of the first channel is related to the transient identifiers of the n channels.

In an embodiment, the decoder side may decode a bitstream, to obtain the transient identifier of the first channel.

An encoder side may also perform transient detection on the channel, write the transient identifier into the bitstream, and transmit the bitstream to the decoder side. In this way, the decoder side may obtain the transient identifier of the first channel by decoding the bitstream.
Operation 402: Obtain a reconstructed signal with the first channel when the transient identifier indicates that a transient signal exists on the first channel.

The decoder side may perform direct decoding on the received bitstream, to obtain a reconstructed signal with a second channel, where the second channel is a channel on which direct decoding is performed in the C channels; and obtain the reconstructed signal with the first channel based on the reconstructed signal with the second channel.

The reconstructed scene audio signal is an audio signal includes the C channels. C is a positive integer. The decoder side may decode the bitstream by using at least two decoding schemes, to obtain the audio signal includes the C channels. The at least two decoding schemes include direct decoding.

For example, N=3, C=16, the reconstructed scene audio signal is an audio signal includes 16 channels, and the 16 channels are numbered from 1 to 16.

TABLE 1

| Channel | | | | |
|---|---|---|---|---|
| number | 256 kbps | 384 kbps | 512 kbps | 768 kbps |
| 1 | Direct encoding | Direct encoding | Direct encoding | Direct encoding |
| | and decoding | and decoding | and decoding | and decoding |
| 2 | Direct encoding | Direct encoding | Direct encoding | Direct encoding |
| | and decoding | and decoding | and decoding | and decoding |
| 3 | Direct encoding | Direct encoding | Direct encoding | Direct encoding |
| | and decoding | and decoding | and decoding | and decoding |
| 4 | Direct encoding | Direct encoding | Direct encoding | Direct encoding |
| | and decoding | and decoding | and decoding | and decoding |
| 5 | De-correlation | De-correlation | Direct encoding | Direct encoding |
| | | | and decoding | and decoding |
| 6 | Spatial encoding | Spatial encoding | Direct encoding | Direct encoding |
| | and decoding | and decoding | and decoding | and decoding |
| 7 | Spatial encoding | Spatial encoding | Spatial encoding | Direct encoding |
| | and decoding | and decoding | and decoding | and decoding |
| 8 | Spatial encoding | Spatial encoding | Spatial encoding | Direct encoding |
| | and decoding | and decoding | and decoding | and decoding |
| 9 | De-correlation | De-correlation | Spatial encoding | Direct encoding |
| | | | and decoding | and decoding |
| 10 | De-correlation | De-correlation | De-correlation | De-correlation |
| 11 | Spatial encoding | Spatial encoding | Spatial encoding | Spatial encoding |
| | and decoding | and decoding | and decoding | and decoding |
| 12 | Spatial encoding | Spatial encoding | Spatial encoding | Spatial encoding |
| | and decoding | and decoding | and decoding | and decoding |
| 13 | Spatial encoding | Spatial encoding | Spatial encoding | Spatial encoding |
| | and decoding | and decoding | and decoding | and decoding |
| 14 | Spatial encoding | Spatial encoding | Spatial encoding | Spatial encoding |
| | and decoding | and decoding | and decoding | and decoding |
| 15 | Spatial encoding | Spatial encoding | Spatial encoding | Spatial encoding |
| | and decoding | and decoding | and decoding | and decoding |
| 16 | De-correlation | De-correlation | De-correlation | De-correlation |

TABLE 2

| Channel | | | | |
|---|---|---|---|---|
| number | 256 kbps | 384 kbps | 512 kbps | 768 kbps |
| 1 | Direct encoding | Direct encoding | Direct encoding | Direct encoding |
| | and decoding | and decoding | and decoding | and decoding |
| 2 | Direct encoding | Direct encoding | Direct encoding | Direct encoding |
| | and decoding | and decoding | and decoding | and decoding |
| 3 | Direct encoding | Direct encoding | Direct encoding | Direct encoding |
| | and decoding | and decoding | and decoding | and decoding |
| 4 | Direct encoding | Direct encoding | Direct encoding | Direct encoding |
| | and decoding | and decoding | and decoding | and decoding |
| 5 | De-correlation | De-correlation | Direct encoding | Direct encoding |
| | | | and decoding | and decoding |
| 6 | Spatial encoding | Spatial encoding | Direct encoding | Direct encoding |
| | and decoding | and decoding | and decoding | and decoding |
| 7 | Spatial encoding | Spatial encoding | Spatial encoding | Spatial encoding |
| | and decoding | and decoding | and decoding | and decoding/De- |
| | | | | correlation |
| 8 | Spatial encoding | Spatial encoding | Spatial encoding | Direct encoding |
| | and decoding | and decoding | and decoding | and decoding |
| 9 | De-correlation | De-correlation | Spatial encoding | Direct encoding |
| | | | and decoding | and decoding |
| 10 | De-correlation | De-correlation | De-correlation | De-correlation |
| 11 | Spatial encoding | Spatial encoding | Spatial encoding | Spatial encoding |
| | and decoding | and decoding | and decoding | and decoding |
| 12 | Spatial encoding | Spatial encoding | Spatial encoding | Spatial encoding |
| | and decoding | and decoding | and decoding | and decoding |
| 13 | Spatial encoding | Spatial encoding | Spatial encoding | Spatial encoding |
| | and decoding | and decoding | and decoding | and decoding |
| 14 | Spatial encoding | Spatial encoding | Spatial encoding | Spatial encoding |
| | and decoding | and decoding | and decoding | and decoding |
| 15 | Spatial encoding | Spatial encoding | Spatial encoding | Spatial encoding |
| | and decoding | and decoding | and decoding | and decoding |
| 16 | De-correlation | De-correlation | De-correlation | De-correlation |

Table 1 and Table 2 each show a configuration example of an encoding and decoding method for a third-order HOA signal at different rates. Table 1 is used as an example.

When the rate is 256 kbps, channels on which direct decoding is performed include channels 1 to 4, channels on which spatial decoding is performed include channels 6 to 8 and channels 11 to 15, and channels on which de-correlation is performed include channels 5, 9, 10, and 16.

When the rate is 384 kbps, channels on which direct decoding is performed include channels 1 to 4, channels on which spatial decoding is performed include channels 6 to 8 and channels 11 to 15, and channels on which de-correlation is performed include channels 5, 9, 10, and 16.

When the rate is 512 kbps, channels on which direct decoding is performed include channels 1 to 6, channels on which spatial decoding is performed include channels 7 to 9 and channels 11 to 15, and channels on which de-correlation is performed include channels 10 and 16.

When the rate is 768 kbps, channels on which direct decoding is performed include 1 to 9, channels on which spatial decoding is performed include 11 to 15, and channels on which de-correlation is performed include 10 and 16.

With reference to the embodiment shown in FIG. 3, a first reconstructed signal obtained by decoding the bitstream by the decoder side is an audio signal includes all channels on which direct decoding is performed, and the reconstructed signal with the second channel may be an audio signal includes any channel in the first reconstructed signal. For example, when the rate is 768 kbps, the reconstructed signal with the second channel is an audio signal includes any one of channels 1 to 9.

In an embodiment of the application, the second channel may be the channel W (namely, a channel numbered 1) in the C channels in the reconstructed scene audio signal.

In an embodiment, the decoder side may directly copy the reconstructed signal with the second channel as the reconstructed signal with the first channel.

In an embodiment, the decoder side may perform de-correlation based on the reconstructed signal with the second channel, to obtain the reconstructed signal with the first channel.

In an embodiment of the application, the decoder side implements, based on a transient identifier of a channel, transient recovery on a reconstructed signal with a channel on which a transient signal exists, so that a transient signal in a scene audio signal can be processed, to improve quality of a reconstructed scene audio signal and auditory experience of a user.

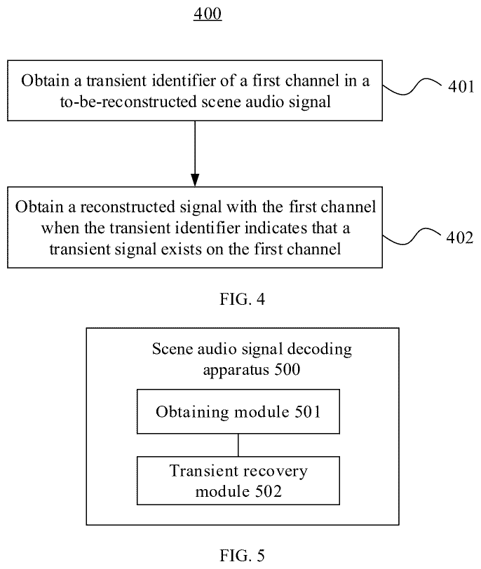

FIG. 5 is a diagram of a structure of a scene audio signal decoding apparatus 500 according to an embodiment of the application. As shown in FIG. 5, the scene audio signal decoding apparatus 500 in an embodiment may be used on a decoder side. The scene audio signal decoding apparatus 500 may include an obtaining module 501 and a transient recovery module 502.

The obtaining module 501 is configured to obtain a transient identifier of a first channel in a to-be-reconstructed scene audio signal. The to-be-reconstructed scene audio signal includes C channels, the C channels include a channel on which direct decoding is performed and a channel on which direct decoding is not performed, the first channel is a channel on which direct decoding is not performed, the transient identifier indicates whether a transient signal exists on the corresponding channel, and C is a positive integer. The transient recovery module 502 is configured to obtain a reconstructed signal with the first channel when the transient identifier indicates that a transient signal exists on the first channel.

In an embodiment, the first channel is a channel on which de-correlation is performed.

In an embodiment, the obtaining module 501 is configured to perform transient detection on the first channel, to obtain the transient identifier of the first channel.

In an embodiment, the obtaining module 501 is configured to: obtain a transient identifier of a channel W in the C channels, and use the transient identifier of the channel W as the transient identifier of the first channel.

In an embodiment, the obtaining module 501 is configured to: obtain transient identifiers of n channels in the C channels, where all the n channels are channels on which direct decoding is performed, and n is an integer greater than 1; and obtain the transient identifier of the first channel based on the transient identifiers of the n channels.

In an embodiment, the obtaining module 501 is configured to decode a bitstream, to obtain the transient identifier of the first channel.

In an embodiment, the transient recovery module 502 is configured to: perform direct decoding on a received bitstream, to obtain a reconstructed signal with a second channel, where the second channel is a channel on which direct decoding is performed in the C channels; and obtain the reconstructed signal with the first channel based on the reconstructed signal with the second channel.

In an embodiment, the transient recovery module 502 is configured to perform de-correlation based on the reconstructed signal with the second channel, to obtain the reconstructed signal with the first channel.

In an embodiment, the transient recovery module 502 is configured to use the reconstructed signal with the second channel as the reconstructed signal with the first channel. In an embodiment, the second channel is the channel W in the C channels.

The apparatus in an embodiment may be configured to perform the technical solutions in the method embodiment shown in FIG. 4. An implementation principle and technical effect of the apparatus are similar to those in the method embodiment. Details are not described herein again.

In an embodiment, operations in the foregoing method embodiments can be implemented by using a hardware integrated logic circuit in the processor, or by using instructions in a form of software. The processor may be a general-purpose processor, a digital signal processor (DSP), an application-specific integrated circuit (ASIC), a field programmable gate array (FPGA) or another programmable logic device, a discrete gate or transistor logic device, or a discrete hardware component. The general-purpose processor may be a microprocessor, or the processor may be any conventional processor or the like. The operations of the methods disclosed in embodiments of this application may be directly presented as being performed and completed by a hardware encoding processor, or performed and completed by a combination of hardware and a software module in an encoding processor. A software module may be located in a mature storage medium in the art, such as a random access memory, a flash memory, a read-only memory, a programmable read-only memory, an electrically erasable programmable memory, or a register. The storage medium is located in the memory, and a processor reads information in the memory and completes the operations in the foregoing methods in combination with hardware of the processor.

The memory mentioned in the foregoing embodiments may be a volatile memory or a nonvolatile memory, or may include both a volatile memory and a nonvolatile memory. The nonvolatile memory may be a read-only memory (ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (RAM), used as an external cache. Through example but not limitative description, many forms of RAMs may be used, for example, a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchronous link dynamic random access memory (synchlink DRAM, SLDRAM), and a direct rambus dynamic random access memory (direct rambus RAM, DR RAM). It should be noted that the memory of the systems and methods described in this specification includes but is not limited to these and any memory of another proper type.

One of ordinary skilled in the art may be aware that, in combination with the examples described in embodiments disclosed in this specification, units and algorithm steps may be implemented by electronic hardware or a combination of computer software and electronic hardware. Whether the functions are performed by hardware or software depends on particular applications and design constraint conditions of the technical solutions. One of ordinary skilled in the art may use different methods to implement the described functions for each particular application, but it should not be considered that the implementation goes beyond the scope of this application.

It may be clearly understood by one of ordinary skilled in the art that, for the purpose of convenient and brief description, for a detailed working process of the foregoing system, apparatus, and unit, refer to a corresponding process in the foregoing method embodiments. Details are not described herein again.

In the several embodiments provided in this application, it should be understood that the disclosed system, apparatus, and method may be implemented in another manner. For example, the described apparatus embodiment is merely an example. For example, division into the units is merely logical functional division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electrical, mechanical, or another form.

The units described as separate parts may or may not be physically separate, and parts displayed as units may or may not be physical units, may be located in one place, or may be distributed on a plurality of network units. Some or all of the units may be selected according to an actual requirement, to achieve the objectives of the solutions of embodiments.

In addition, functional units in embodiments of this application may be integrated into one processing unit, each of the units may exist alone physically, or two or more units may be integrated into one unit.

When the functions are implemented in the form of a software functional unit and sold or used as an independent product, the functions may be stored in a computer-readable storage medium. Based on such an understanding, technical solutions of this application essentially, or a part contributing to the conventional technology, or some of technical solutions may be implemented in a form of a software product. The computer software product is stored in a storage medium, and includes several instructions for instructing a computer device (a personal computer, a server, a network device, or the like) to perform all or some of the operations of the methods described in embodiments of this application. The storage medium includes various media that can store program code, for example, a USB flash drive, a removable hard disk drive, a read-only memory (ROM), a random access memory (RAM), a magnetic disk, or an optical disc.

The foregoing descriptions are merely implementations of this application, but are not intended to limit the protection scope of this application. Any variation or replacement readily figured out by one of ordinary skilled in the art within the technical scope disclosed in this application shall fall within the protection scope of this application. Therefore, the protection scope of this application shall be subject to the protection scope of the claims.

What is claimed is:

1. A scene audio signal decoding method, comprising:
obtaining a transient identifier of a first channel in a-scene audio signal to be reconstructed, wherein the scene audio signal comprises C channels, the C channels comprise a channel on which direct decoding is performed and a channel on which direct decoding is not performed, the first channel is a channel on which direct decoding is not performed, the transient identifier indicates whether a transient signal exists on the corresponding channel, and C is a positive integer; and
obtaining a reconstructed signal associated with the first channel when the transient identifier indicates that a transient signal exists on the first channel.

2. The method according to claim 1, wherein the first channel is a channel on which de-correlation is performed.

3. The method according to claim 1, wherein obtaining the transient identifier of the first channel in the scene audio signal comprises:
performing transient detection on the first channel, to obtain the transient identifier of the first channel.

4. The method according to claim 1, wherein obtaining the transient identifier of the first channel in the scene audio signal comprises:
obtaining a transient identifier of a channel W in the C channels, and
using the transient identifier of the channel W as the transient identifier of the first channel.

5. The method according to claim 1, wherein obtaining the transient identifier of the first channel in the scene audio signal comprises:
obtaining transient identifiers of n channels in the C channels, wherein all the n channels are channels on which direct decoding is performed, and n is an integer greater than 1; and
obtaining the transient identifier of the first channel based on the transient identifiers of the n channels.

6. The method according to claim 1, wherein obtaining the transient identifier of the first channel in the scene audio signal comprises:
decoding a bitstream, to obtain the transient identifier of the first channel.

7. The method according to claim 1, wherein obtaining the reconstructed signal associated with the first channel comprises:
performing direct decoding on a received bitstream, to obtain a reconstructed signal associated with a second channel on which direct decoding is performed in the C channels; and
obtaining the reconstructed signal associated with the first channel based on the reconstructed signal associated with the second channel.

8. The method according to claim 7, wherein obtaining the reconstructed signal associated with the first channel based on the reconstructed signal associated with the second channel comprises:
performing de-correlation based on the reconstructed signal associated with the second channel, to obtain the reconstructed signal associated with the first channel.

9. The method according to claim 7, wherein obtaining the reconstructed signal associated with the first channel based on the reconstructed signal associated with the second channel comprises:
using the reconstructed signal associated with the second channel as the reconstructed signal associated with the first channel.

10. The method according to claim 7, wherein the second channel is the channel W in the C channels.

11. An electronic device, comprising:
a processor; and
a memory coupled to the processor to store instructions, which when executed by the processor, cause the processor to:
obtain a transient identifier of a first channel in a scene audio signal to be reconstructed, wherein the scene audio signal comprises C channels, the C channels comprise a channel on which direct decoding is performed and a channel on which direct decoding is not performed, the first channel is a channel on which direct decoding is not performed, the transient identifier indicates whether a transient signal exists on the corresponding channel, and C is a positive integer; and
obtain a reconstructed signal associated with the first channel when the transient identifier indicates that a transient signal exists on the first channel.

12. The electronic device according to claim 11, wherein the first channel is a channel on which de-correlation is performed.

13. The electronic device according to claim 11, wherein the instructions further cause the processor to:
perform transient detection on the first channel, to obtain the transient identifier of the first channel.

14. The electronic device according to claim 11, wherein the instructions further cause the processor to:
obtain a transient identifier of a channel W in the C channels, and using the transient identifier of the channel W as the transient identifier of the first channel.

15. The electronic device according to claim 11, wherein the instructions further cause the processor to:
obtain transient identifiers of n channels in the C channels, wherein all the n channels are channels on which direct decoding is performed, and n is an integer greater than 1; and
obtain the transient identifier of the first channel based on the transient identifiers of the n channels.

16. The electronic device according to claim 11, wherein the instructions further cause the processor to:
decode a bitstream, to obtain the transient identifier of the first channel.

17. The electronic device according to claim 11, wherein the instructions further cause the processor to:
perform direct decoding on a received bitstream, to obtain a reconstructed signal associated with a second channel on which direct decoding is performed in the C channels; and
obtain the reconstructed signal associated with the first channel based on the reconstructed signal associated with the second channel.

18. The electronic device according to claim 17, wherein the instructions further cause the processor to:
perform de-correlation based on the reconstructed signal associated with the second channel, to obtain the reconstructed signal associated with the first channel.

19. The electronic device according to claim 17, wherein the instructions further cause the processor to:
use the reconstructed signal associated with the second channel as the reconstructed signal associated with the first channel.

20. A non-transitory computer-readable storage medium having instructions stored therein, which when executed by a processor, cause the processor to:
obtain a transient identifier of a first channel in a scene audio signal to be reconstructed, wherein the to-be-reconstructed scene audio signal comprises C channels, the C channels comprise a channel on which direct decoding is performed and a channel on which direct decoding is not performed, the first channel is a channel on which direct decoding is not performed, the transient identifier indicates whether a transient signal exists on the corresponding channel, and C is a positive integer; and
obtain a reconstructed signal associated with the first channel when the transient identifier indicates that a transient signal exists on the first channel.
